(19) United States
(12) Patent Application Publication
(10) Pub. No.: US 2009/0166586 A1
(43) Pub. Date: Jul. 2, 2009

(54) Long After-Glow Photoluminescent Material

(75) Inventor: Nagendra N. Beladakere, Victoria (AU)

Correspondence Address: DIEHL SERVILLA LLC, 77 BRANT AVE, SUITE 210, CLARK, NJ, 07066, US

(73) Assignee: VISIONGLOW IP PTY LTD., Melbourne, Victoria (AU)

(21) Appl. No.: 12/091,675

(22) PCT Filed: Oct. 27, 2006
(86) PCT No.: PCT/AU2006/001608

§ 371 Date: Jul. 8, 2008

(30) Foreign Application Priority Data
Oct. 28, 2005 (AU) 2005905975

(51) Int. Cl. C09K 11/70; C09K 11/71

(52) U.S. Cl. 252/301.4 P

(57) ABSTRACT

The present invention provides a photoluminescent material comprising a composition of: aL. bm. cAL. dSi. pP. O. :fR Formula (I) wherein L is selected from Na and/or K; M is a divalent metal selected from one or more of the group consisting of Sr, Ca, Mg and Ba; Al, Si, P and O represent their respective elements; R is selected from one or more rare earth element activators; and wherein the variables a, b, c, d, p and f are: 0.0<a<0.1 0.0<b<0.3 0.0<c<0.4 0.0<d<0.3 0.0<p<0.5 0.0<f<0.25, with the proviso that at least one of the variables d and p is, and at least one of the variables a and b is 0. There is also provided a method involving a sol-gel process of manufacturing the photoluminescent material comprising. There is also provided the use of said photoluminescent material in glass-like end products.

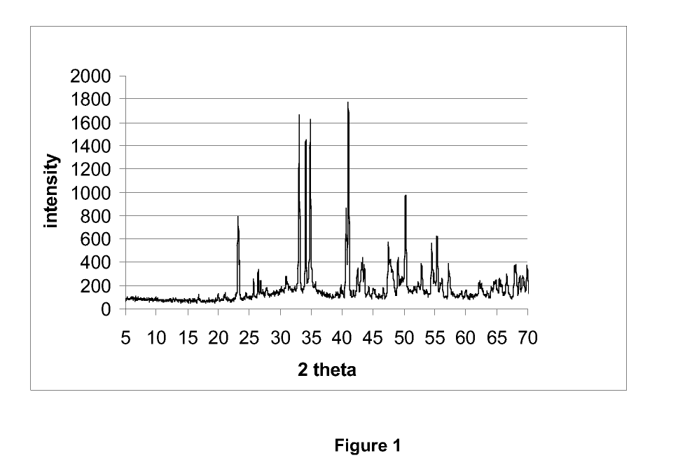

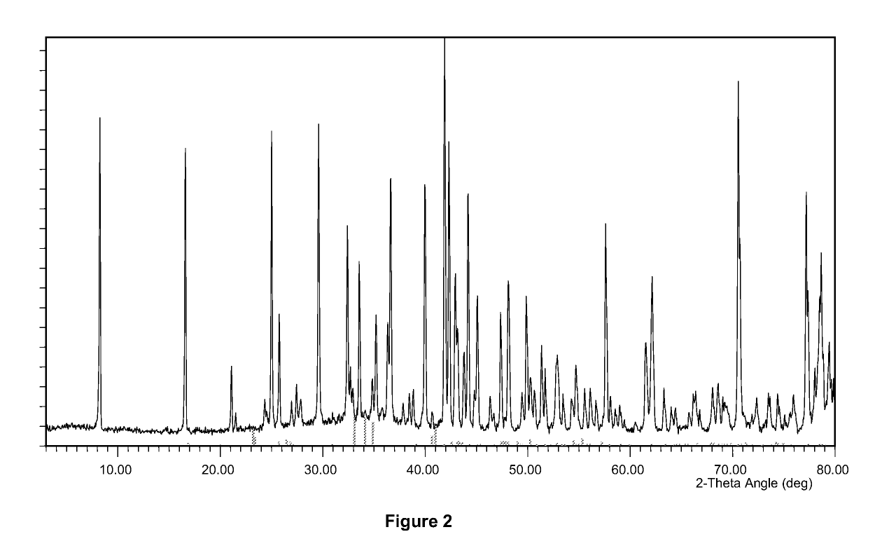

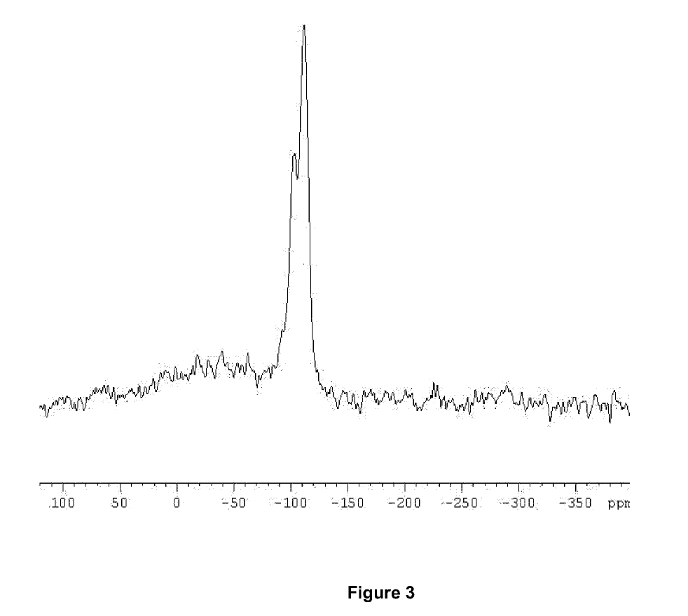

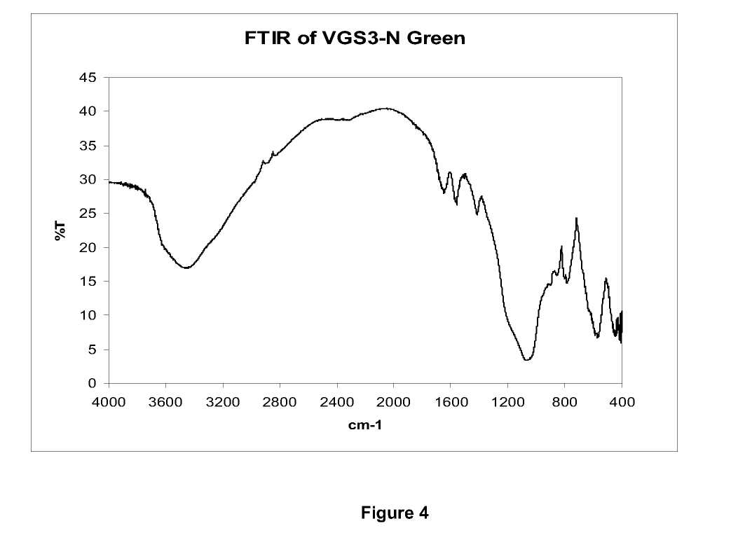

### FIELD

The invention relates to long after-glow photoluminescent material comprised of rare earth activated, divalent metal complexes and a method of preparing such long after-glow photoluminescent material.

### BACKGROUND

Photoluminescent materials have existed in many forms, some occurring naturally in the form of phosphorescent inorganic minerals in the earth. A series of special minerals, amongst others, which give rise to the phenomenon of photoluminescence are known as the lanthanide series of elements in the periodic table. The lanthanides belong to a group commonly known as rare earths. The unique electronic structure of these elements with f-electrons and partially filled d-levels offer an excellent opportunity to create electron triplet states with long lifetimes. These states in turn give rise to phosphorescence. When very small amounts of compounds such as oxides, halides, nitrates, etc of these lanthanide elements are amalgamated with select inorganic compounds and sintered under controlled heat and atmospheric conditions, the result can be a photoluminous material. Such material absorbs energy from radiant sources when exposed to them, and emits this energy in the form of luminous photons over a long period when compared to the short exposure time.

Honeywell's subsidiary Riedel De Haën of Germany were among the early developers of a photoluminous pigment based on zinc sulphide, which has been produced commercially since the early 1900s.

More recently other phosphorescent crystals “doped” with rare earths such as europium and dysprosium as activators have been used. For example, aluminates of calcium and strontium doped with rare earths have been synthesized to give an improved intensity of illumination over a longer period when compared to zinc sulphide. The rare-earth elements in these crystals are often referred to as ‘activators’ as their unique electronic configuration is the source of phosphorescence. These substances, sometimes known as ‘glow in the dark’ pigments in industry and trade parlance, are being more commonly used in domestic and industrial situations.

Such materials have been used in making luminous solvent based paints, articles moulded and extruded from plastics, ceramic glazes and many others. However, incorporating most long-decay photoluminescent material into other materials poses many challenges, sometimes insurmountable, as the crystals are abrasive and can damage the machinery. The aluminates, for example, can form a hard cementitious mass in water thus making it difficult to use in water-based formulations.

Photoluminescent materials can also be prepared by adding europium and other rare earth elements to alkaline earth metal aluminates. For example strontium aluminate crystals doped with two rare-earth elements has been utilised as photoluminescent material.

It is desirable to produce an improved photoluminescent material with persistent after-glow characteristics and particularly in which the rate of decay of the afterglow is reduced relative to traditionally used photoluminescent material, such as zinc sulphide.

Reduced rate of decay has become a desirable characteristic as it results in photoluminescent material that can maintain persistent after-glow for longer periods.

It is also desirable to produce photoluminescent material with persistent after-glow characteristics and that can be incorporated into other materials, i.e. able to be formulated into other products more easily than traditional photoluminescent material, for example, zinc sulphide.

It is also desirable to provide a process to manufacture photoluminescent material, the process being one that is aligned with the principles of green chemistry.

### SUMMARY

In a first aspect, the present invention provides a photoluminescent material comprising a composition of:

aL.bM.cAl.dSi.pP.O.:fR Formula (1)

wherein L is selected from Na and/or K;
M is a divalent metal selected from one or more of the group consisting of Sr, Ca, Mg and Ba;
Al, Si, P and O represent their respective elements;
R is selected from one or more rare earth element activators;
and wherein the variables a, b, c, d, p and f are:
O.O≦a≦0.1
0.0≦b≦0.3
0.0≦c≦0.4
0.0≦d≦0.3
0.0≦p≦0.5
0.0<f≦0.25, with the proviso that
at least one of the variables d and p is >0, and at least one of the variables a and b is >0. Preferably, the variable b is >0.

Embodiments of the invention include a composition of the above formula in which the molar ratio of d:c is in the range 0.01 to 2.0.

In a further aspect, the present invention provides a method of manufacturing a long-decay photoluminescent material as described above. The method comprises the step of providing an alkaline earth metal aluminate and reacting with a phosphorus containing acid resulting in an alkaline earth metal alumino-phosphate. The alumino phosphate can be doped by one or more rare earth element activators before or after reaction with P-containing acid.

As a separate step, the starting material alkaline earth metal aluminate is reacted with liquid silicate resulting in formation of a complex of alumino-silicate. The alumino-silicate can be doped by one or more rare earth element activators before or after reaction with liquid silicate.

Alternatively, the alumino phosphate is reacted with liquid silicate resulting in a complex of an alkaline earth metal alumino-phospho-silicate.

In an even further aspect, the present invention provides a use of said long-decay photoluminescent material in long after-glow products. The products include paints, extrudable and moldable plastics and/or dispersions. solvent based paints, ceramics, coatings, moulded ceramic glazes and the like. In particular, due to the incorporation of silicate into the complex, the photoluminescent material of the present invention is suited for incorporation into glass-like products. There are wide variety of applications for glass-like product. A few examples are kitchen splash backs, jewelry, furniture, glasses for use in the home etc.

### DETAILED DESCRIPTION

In a first aspect, the present invention provides a photoluminescent material comprising a composition of:

aL.bM.cAl.dSi.pP.O.:fR Formula (1)

wherein L is selected from Na and/or K;
M is a divalent metal selected from one or more of the group consisting of Sr, Ca, Mg and Ba;
Al, Si, P and O represent their respective elements;
R is selected from one or more rare earth element activators;
and wherein the variables a, b, c, d, p and f are:
O.O≦a≦0.1
0.0≦b≦0.3
0.0≦c≦0.4
0.0≦d≦0.3
0.0≦p≦0.5
0.0<f≦0.25, with the proviso that
at least one of the variables d and p is >0, and at least one of the variables a and b is >0.

Preferably, the variable b is >0.

In an embodiment (1), the variables a, b, c, d, p and f are:

O.0≦a≦0.1
0.1≦b≦0.3
0.0≦c≦0.4
0.05≦d≦0.3
0.1≦p≦0.5
0.0<f≦0.25.

In an alternative embodiment of embodiment 1 above, (1a), the variables a, b, c, p and f are as above and the variable d is 0.0≦d≦0.3.

In an alternative embodiment of embodiment 1 above, (1b), the variables a, b, c, d and f are as above and the variable p is 0.0≦p≦0.5

In another embodiment (2), the variables a, b, c, d, p and f are:

O.O1≦a≦0.1
0.0≦b≦0.3
0.0≦c≦0.4
0.05≦d≦0.3
0.1≦p≦0.5
0.0<f≦0.25

In an alternative embodiment of 2 above, (2a), the variables a, b, c, p and f are as above and the variable d is 0.0≦d≦0.3.

In an alternative embodiment of embodiment 2 above, (2b), the variables a, b, c, d and f are as above and the variable p is 0.0≦p≦0.5

In an even further embodiment, the variables a, b, c, d, p and f are:

O.O≦a≦0.1
0.2≦b≦0.3
0.05≦c≦0.3
0.05≦d≦0.2
0.1≦p≦0.5, and
0.0<f≦0.25

In a further embodiment of the present invention, there is provided an improved long afterglow alkali earth aluminate-phosphate-silicate comprising of a material expressed by a general composition formula of

aL . . . bM . . . cAl . . . dSi . . . pP . . . O . . . :fR

Where L is an alkali metal, M is at least one element from a selection of Sr, Ca, Mg and Ba; L is an alkali metal from Na or K; R is a rare-earth element activator; Al, Si, P and O are element symbols; a, b, c, d, p and f are variables expressed in moles per 100 gms of material, the values of which are expressed by the following relations

### 0.LE . . . a . . . LE.0.05

### 0.2.LE . . . b . . . LE.0.3

### 0.2.LE . . . c . . . LE.0.3

### 0.05.LE . . . d . . . LE.0.2

### 0.1.LE . . . p . . . LE.0.5

### 0.001.LE . . . f . . . LE.0.1

LE stands for the symbol ≦.

The variables of the above formula are expressed in moles per 100 g of material.

It is to be understood that the above formula (1) and similar formula disclosed herein unless indicated otherwise are intended to represent the ratio of elemental constituents present in the composition of long-decay photoluminescent material. There has been no suggestion or representation of the molecular composition of the individual crystal phases present in the photoluminescent material. The above formula has been generated by analytical techniques such as X-ray diffraction, gravimetric analysis, ICP-AES (Inductively Coupled Plasmon Atomic Electron Spectroscopy) etc.

The above composition has been devised with a view to changing the lattice parameters of the traditional spinel structure of a divalent metal aluminate as previously used in the manufacture of photoluminescent material. Changing the lattice parameters is anticipated to impart different properties to the photoluminescent material. The altered lattice parameters of the composition of the present invention results in a material with a reduced rate of decay of the afterglow than the traditional photoluminescent material based on zinc sulphide. A whiter daylight colour is observed in some embodiments of the photoluminescent material of the present invention.

The retention of enhanced brightness for a longer period is of more value in emergency applications, such as exit signs etc, than the brightness of initial glow.

It is anticipated that some or all of the aluminate components of a traditional divalent metal aluminate by phosphate and/or silicate components results in a more hexagonal lattice structure. The deviation away from a hard monoclinic spinel-like structure that is predominantly oxide-like, to what is envisaged to be a more hexagonal structure, is believed to result in a softer composition.

### Alkaline Earth Metal

M is selected from one or more of the group consisting of Sr, Ca, Mg and Ba. In one embodiment, M comprises a combination of one, two, three or all metals of the group Sr, Ca, Mg and Ba. Preferably, M is Sr. In another embodiment, M is a combination of Sr and Ca. The metal is usually present in the composition as a metal oxide.

The empirical analysis of the composition will usually present the amount of metal present in the composition in its oxide form. In one embodiment, the metal oxide is SrO. In other embodiments of the invention, the metal oxide component comprises a combination of metal oxides. For example, SrO and CaO, SrO and MgO, SrO and BaO, CaO and MgO, CaO and BaO, MgO and BaO. A combination of three of the metal oxides mentioned above is also envisaged. In a preferred embodiment, the metal oxide component represents at least one metal oxide selected from the group consisting of CaO and SrO. In another embodiment, the metal oxide component consists of CaO and SrO.

The variable “b”, defining the amount of M present in the composition is expressed in terms of mol/100 g as 0.0≦b≦0.3. Preferably, the variable b is 0.1≦b≦0.3. Further preferably, the variable b is 0.15≦b≦0.3. Even further preferably, the variable b is 0.2≦b≦0.3.

### Alkali Metal: L

The alkali component L is selected from the group consisting of Na and/or K. In one or more embodiments, the component L consists of Na or K cations. In another embodiment, L consists a combination of Na and K cations.

The variable “a”, defining the amount of L is expressed in terms of mol/100 g as O.O≦a≦0.1. Preferably, the variable a is within the range O.O1≦a≦0.1. Further preferably, the variable a is within the range O.O1≦a≦0.05. Even further preferably, the range is O.O2≦a≦0.04.

### Rare Earth Element Activator

The amount of rare earth element(s) present in the photoluminescent material can be extremely small relative to the other constituents of the photoluminescent material, and still contribute the characteristics of photoluminescence to the material. The variable “f” which defines the amount of the rare earth element activator(s) can be very small and its lower limit is defined as being greater than 0 to indicate this. In a preferred embodiment a second rare earth is present in the composition. The amount of the second rare earth is defined by the range of 0≦f1<0.05.

According to one embodiment, R is Eu²⁺. Eu²⁺ can be used as the single rare earth activator. However, enhanced long decay phosphorescence can be observed if the Eu²⁺ activator is combined with a second or increased number of rare earth activators.

The rare-earth metal represented by “f” in formula (I) is selected from one or more of the group consisting of Ce, Pr, Nd, Pm, Sm, Eu, Gd, Tb, Dy, Ho, Er, Tm and Yb and Lu. Preferably, the rare earth component comprises Eu. Further preferably, the rare earth component comprises Eu and one or more further rare earth elements selected from Ce, Pr, Nd, Pm, Sm, Eu, Gd, Tb, Dy, Ho, Er, Tm and Yb and Lu. In still another preferred embodiment, the further rare earth element(s) are selected from one or more of Dy, Ce, Nd, Pr, Sm, Tb, Tm and Yb.

Embodiments in which more than two rare earths are present are envisaged in the present invention. The addition of more rare earths does not materially effect the characteristics, particularly the stability, of any products containing the photoluminescent material, as the rare earths are present in relatively small amounts. The limiting factor to adding more rare earths relates to the added cost as they are expensive materials.

Photoluminescent material containing Eu²⁺ as the only rare earth activator are not as long-lasting as would be ultimately desirable for some applications. However, it is suitable for some applications which require only short after-glow characteristics such as coatings on the internal surfaces of lamp shades. These coatings assist in amplifying the brightness of the lamp, but do not extend to after-glow when the lamp is switched off. Long decay photoluminescence is surprisingly enhanced by including one or more additional rare-earth activators.

In an embodiment comprising two or more rare earth elements it is preferred that one of the rare earths is present in a larger amount than the other(s). For example, if one of the rare earths is Eu²⁺, the range of molar ratios of Eu²⁺:other rare earth(s) can be defined by: 1:0.01 to 1:50. A preferred ratio range can be defined by 1:0.1 to 1:10. Another preferred ratio range can be defined by 1:2 to 1:5.

The choice of rare earth present in the composition as well as the choice of rare earths, if more than one, and their relative ratios determines the nature of the glow of the photoluminescent material. This ultimately determines the nature of the glow of the final product into which the long-decay photoluminescent material is incorporated.

The remaining components of the composition are Al, Si and/or P. It is believed that these components are present in the composition in their aluminate, silicate and/or phosphate forms respectively. It is envisaged that replacement or substitution of some or all of the aluminate in a traditional divalent alkaline earth metal aluminate by phosphate and/or silicate results in alteration of the anion size in the resulting photoluminescent material, and therefore alteration of the lattice parameters and their resultant properties.

It is believed that the reduced rate of decay properties are achieved for the subject rare-earth activated, divalent metal aluminate/phosphate/silicate due to the replacement of some or all of the aluminate with phosphate and/or silicate.

### Process

The proposed process of manufacturing the photoluminescent material of the present invention initially involves manufacture of a divalent metal aluminate followed by reaction with phosphoric acid to replace some or all of the aluminate component. The divalent metal aluminate may be doped with one or more rare earth element activators, or the resulting P-substituted material can be doped with one or more rare earth element activators.

This is optionally followed by reaction with a silicate source, for example, liquid silicate. This results in the formation of a complex of phospho-alumino-silicate.

Alternatively, the divalent metal aluminate can be reacted with reacted with a silicate source, for example, liquid silicate, to produce an alumino-silicate.

The process of manufacture of the photoluminescent material can be described as a sol-gel process. It is aligned with the principles of green chemistry.

### Phosphate:

In one embodiment, phosphoric acid in an amount of 3-7 parts by volume to 1 part by weight of aluminate is preferred for reaction between an aluminate and phosphoric acid.

Commercially available phosphoric acid is a mixture of various phosphoric acids. The oxidation potentials of P(I), P(III) and P(V) vary in alkaline and acidic media allowing us a range of values for designing reactions.

### Silicate(s)

The silicate part of the new improved crystal can be forged in the last step preparation. This novel method of introducing silica by gelling with liquid silicates is a safe approach and also offers control over the nature of silicate formed. By controlling this process, the effective electron energy band gap of the resulting crystal can be altered as required.

The photoluminescent material of the present invention has been found to be easy to blend with a wide variety of substrates. In particular, glass-like substrates have been found to be particularly suitable and the photoluminescent material of the present invention can be formulated into glass-like end products.

### The Process

The process has been described as a sol-gel process.

In one embodiment, the mixing of aluminates with phosphoric acid is done in a stainless steel container with constant stirring at rates of 50-100 revs/minute. The reaction is exothermic and is controlled by a cooling mechanism. Some gases released during the reaction are dissolved in water and disposed accordingly.

Whether the reaction is complete or not is checked by visual as well as quantitative means. The slurry will be pale white when the reaction is complete. The pH of the resulting solution lies between 5.5 and 7.5.

When the reaction is complete, if silicate is to be incorporated to the complex a measured amount of liquid silicate (sodium or potassium silicate) is added to the container and the mixing is continued for 2-3 hours. This process increases the pH of the slurry. The pH of the slurry is then adjusted to 7.0 by adding acetic acid. Acetic acid is chosen as this enhances the brightness of the resulting product.

The slurry is allowed to gel for 3-4 hours after stopping the mixing process. A layer of water is formed on the top and this water is discarded.

The remaining slurry is then transferred into shallow trays and to and cured by heating in an oven between 200 C-400 C for 3-4 hours. The aluminate-phosphate-silicate networks are formed as the slurry loses more water due to heat curing.

Then the product is cooled and powdered. The resulting product is softer and easy to powder. This product is more stable in water. The afterglow is enhanced as discussed earlier in this document.

It is preferred that the strength of the phosphoric acid be between 3-20% for enabling a controlled chemical reaction between an aluminate and phosphoric acid.

Preferably, 1 part by weight of aluminate material will be added to 3-7 parts by volume of above acid for the reaction.

It is preferred that for the above reaction to be complete the mixture be stirred for 2-3 hours at a constant rate of 60 rpm, in a stainless steel container.

The invention also provides another way of providing a silicate component to a photoluminescent material for a wider application.

It is preferred that the silicate component come from any of the liquid silicate sources available such as D, F, H, N and O series of PQ Australia P/L or from KASIL of the same manufacturer.

It is preferred that the percentage of silica in liquid silicate will be between 25-35%.

Preferably, one part by weight of aluminate slurry obtained earlier is mixed with 1-3 parts of liquid silicate and stirred for 2-3 hours.

The resulting slurry is preferably allowed to gel for over 10-12 hours.

The gel is then cured in a convection oven for 4-5 hours at 200 C -450 C.

Preferably, the gel is cooled before being pulverized and screened.

The particle size distribution is preferably between 2-70 microns.

This invention also provides the method of making photoluminescent pigment sol.

Preferably, the sol is an acidified solution containing phosphates, halides and acetates.

This invention also provides the method of gelling with easily available commercial products and those recommended in Green Chemistry principles. These include liquid silicates brightness enhancement and gelling reactions.

The dried product obtained via the method described above is homogenous, whiter and easier to crush. The final product is neutral in water. Upon excitation by standard light sources, a luminous intensity of 258 mcd/m2 at 10 minutes, 41.1 mcd/m2 at 60 minutes and 24.9 mcd/m2 at 90 minutes can be achieved.

### EXAMPLES

The invention will now be described in detail by way of reference only to the following non-limiting examples and drawings.

### Materials and Methods

All starting materials were purchased from various sources such as Ajax Fine Chemicals, Redux Chemicals and local hardware stores. CrCo₃ was bought from Ajax Fine Chemicals in Australia. Rare earth compounds and oxides were purchased from Metall company in China and 4% phosphoric acid was bought from Redux Chemical Supply Pty Ltd Melbourne. Sodium silicate (N grade) was purchased from PQ Corporation.

### Example 1

### Preparation of 0.04Na0.25Sr0.23Al0.12Si0.32PO7:0.005Eu0.02Dy

| | | |
|---|---|---|
| SrCO3 | 148.6 | g |
| Al(OH)3 | 78.0 | g |
| Eu2O3 | 0.943 | g |
| Dy2O3 | 1.879 | g |

### Heating and Pulverising:

Mix the contents thoroughly in a mortar and pestle
Transfer the contents to a crucible
And fire at 1200 C for 2 hours
Cool, crush and mix the contents in the crucible

### Formation of Sol and Gel:

Take 250 ml of 4% Phosphoric acid in a container—preferably a plastic container to which a stirrer is fitted. Add 100 grams of above crushed substance to the acid while stirring. Some heat is released. Continue to stir until the mixture is homogeneous.

Then allow the contents to cool and sediment. Decant the top portion of the liquid. Wash the sediment with 1-2 liters of water until the pH reaches between 7 and 7.5 and keep the sediment. The sediment now is in form of slurry. Take this slurry in a plastic container fitted with a stirrer. Stir the contents at a speed of about 400 rpm. Now slowly add 125 grams of Sodium Silicate (N grade) to this container. The slurry becomes thick. Keep stirring until the slurry is homogenous.

Stop stirring and transfer the slurry into a shallow tray Allow the gelling process in a furnace at 350 C for 4 hours. Cool the product to room temperature.

Wash the product with 2-3 liters of water until the pH of the water is between 7 and 8. Dry the product at 150 C for about 8 hours.

Pulverize to a particle size of 20-30 micrometers

The resulting product has green glow, whiter colour.

### Example 2

### Preparation of Aluminate Silicate 0.032Na0.26Sr0.21Al0.09Si0.25PO7:0.006Eu0.028Dy

| | | |
|---|---|---|
| SrCO3 | 128.6 | g |
| Al(OH)3 | 75.0 | g |
| Eu2O3 | 0.942 | g |
| Dy2O3 | 1.965 | g |

### Heating and Pulverising:

Mix the contents thoroughly in a mortar and pestle
Transfer the contents to a crucible
And fire at 1200 C for 2 hours
Cool, crush and mix the contents in the crucible

### Formation of Sol and Gel:

Take 250 ml of 4% Phosphoric acid in a container—preferably a plastic container to which a stirrer is fitted. Add 100 grams of above crushed substance to the acid while stirring. Some heat is released. Continue stirring until the mixture is homogeneous.

Then allow the contents to cool and sediment. Decant the top portion of the liquid. Wash the sediment with 1-2 liters of water until the pH reaches between 7 and 7.5 and keep the sediment. The sediment now is in form of slurry.

Take this slurry in a plastic container fitted with a stirrer. Continue to stir at a speed of about 400 rpm. Now slowly add 100 grams of Potassium Silicate (from PQ Corporation) to this container. The slurry becomes thick. Keep stirring until the slurry is homogenous.

Stop stirring and transfer the slurry into a shallow tray Allow the gelling process in a furnace at 350 C for 4 hours. Cool the product to room temperature.

Wash the product with 2-3 liters of water until the pH of the water is between 7 and 8. Dry the product at 150 C for about 8 hours.

Pulverize to a particle size of 20-30 micrometers. The resulting product has a green afterglow.

### Example 3

### 0.02Na0.16Sr0.09Ca0.27Al0.09Si0.21PO7:0.007Eu0.026Dy

| | | |
|---|---|---|
| SrCO3 | 43.95 | g |
| CaCO3 | 29.9 | g |
| Al2O3•3H2O | 93.6 | g |
| Eu2O3 | 1.056 | g |
| Dy2O3 | 2.341 | g |

The ingredients are mixed, heated and powdered as in Example 1.

Take 100 ml of 4% Phosphoric acid in a container—preferably a plastic container to which a stirrer is fitted. Add 100 grams of above crushed substance to the acid while stirring. Some heat is released. Continue to stir until the mixture is homogeneous.

Then allow the contents to cool and sediment. Decant the top portion of the liquid. Wash the sediment with 1-2 liters of water until the pH reaches between 7 and 7.5 and keep the sediment. The sediment now is in form of slurry. Take this slurry in a plastic container fitted with a stirrer. Stir the contents at a speed of about 400 rpm. Now slowly add 125 grams of Sodium Silicate (N grade) to this container. The slurry becomes thick. Keep stirring until the slurry is homogenous.

Stop stirring and transfer the slurry into a shallow tray Allow the gelling process in a furnace at 350 C for 4 hours. Cool the product to room temperature.

Wash the product with 2-3 liters of water until the pH of the water is between 7 and 8. Dry the product at 150 C for about 8 hours.

Pulverize to a particle size of 20-30 micrometers

The resulting product has blue-green afterglow in dark.

### Example 4

### 0.024K0.17Sr0.11Ca0.26Al0.10Si0.22PO7:0.007Eu0.026Dy

| | | |
|---|---|---|
| SrCO3 | 43.95 | g |
| CaCO3 | 29.9 | g |
| Al2O3•3H2O | 93.6 | g |
| Eu2O3 | 1.056 | g |
| Dy2O3 | 2.341 | g |

The ingredients are mixed, heated and powdered as in Example 1.

Take 100 ml of 4% Phosphoric acid (supplied by Redox Chemical Supply P/L, Melbourne) in a container—preferably a plastic container to which a stirrer is fitted. Add 100 grams of above crushed substance to the acid while stirring. Some heat is released. Stir until the mixture is homogeneous.

Allow the contents to cool and sediment. Decant the top portion of the liquid. Wash the sediment with 1-2 liters of water until the pH reaches between 7 and 7.5 and keep the sediment. The sediment now is in form of slurry.

Take this slurry in a plastic container fitted with a stirrer. Continue to stir at a speed of about 400 rpm. Now slowly add 100 grams of Potassium Silicate (from PQ Corporation) to this container. The slurry becomes thick. Keep stirring until the slurry is homogenous.

Stop stirring and transfer the slurry into a shallow tray Allow the gelling process in a furnace at 350 C for 4 hours. Cool the product to room temperature.

Wash the product with 2-3 liters of water until the pH of the water is between 7 and 8. Dry the product at 150 C for about 8 hours.

Pulverize to a particle size of 20-30 micrometers. The resulting product has a blue-green afterglow.

### Example 5

Brightness of after glow and length of after glow of photoluminous material. Brightness was evaluated using a widely accepted standard for measuring phosphorescence: DIN 67510 Part 1.

The resulting powders made according to examples 1 and 2 are conditioned under subdued lighting for a period of 20 minutes to allow residual luminescence to decay, after which they were exposed to xenon light for 5 minutes. Measurements of sample afterglow were made using the same Hagner EC1 Luxmeter. Its measuring aperture is circular with a diameter of 10.5 mm. It was mounted at a distance of 50 mm above the sample, and the luminance of the pigment was determined by measuring the illuminance in this configuration, according to the method in 4.4.2.2. of the Standard. However, the smallest measurable illuminance of the Hagner luxmeter is only 0.1 lux, which is much greater than the required level of 10⁻⁵ lux, so a United Detector Technology silicon photodiode detector (model UDT-10DP) with a circular sensitive area of 1.00 cm² was used for low light measurements, together with a current amplifier to allow measurements of the required sensitivity. The UDT device was calibrated against the Hagner meter in the luminescence of the sample at high light levels in the early part of the decay curve. The photodiode was placed in the same position as the luxmeter, that is, 50 mm above the sample surface. Measurements of luminescence began a few seconds after the xenon lamp was switched off. Tests were performed in a temperature-controlled environment with a temperature in the range 22±1° C.

The sample and detector head were enclosed in a light-tight box to allow monitoring of the luminescent decay down to the required level of 0.3 mcd/m2, without interference from stray light.

The result in table 1 below shows that the photoluminous material of examples 1 and 2 is much brighter and retains brightness for a longer period of time when compared with the traditional photoluminescent compound based on zinc sulphide.

| | Luminance after | | | | Duration | |
|---|---|---|---|---|---|---|
| Sample | 1 min | 10 mins | 30 mins | 60 mins | of afterglow | |
| ZnS: Cu | 1 | 1 | 1 | 1 | >170 | mins |
| VGS3-N | 51.5 | 18.3 | 26.1 | 17.9 | >3000 | mins |
| Example | | | | | | |
| 1 | | | | | | |
| VGS3-N | 25.2 | 11.9 | 27.0 | 13.8 | >1500 | mins |
| Example | | | | | | |
| 2 | | | | | | |

It will be understood to persons skilled in the art of invention that many modifications may be made without departing from the spirit scope and of the invention.

What is claimed is:

1. A photoluminescent material comprising a composition of:
aL.bm.cAL.dSi.pP.O.:fR Formula (I)
wherein L is selected from Na and/or K;
M is a divalent metal selected from one or more of the group consisting of Sr, Ca, Mg and Ba;
Al, Si, P and O represent their respective elements;
R is selected from one or more rare earth element activators;
and wherein the variables a, b, c, d, p and f are:
0.0<a<0.1
0.0≦b≦0.3
0.0≦c≦0.4
0.0≦d≦0.3
0.0≦p≦0.5
0.0<f≦0.25, with the proviso that
at least one of the variables d and p is >, and at least one of the variables a and b is >0.

2. A photoluminescent material according to claim 1, wherein the variable b is >0.

3. A photoluminescent material according to claim 1, wherein the variables a, b, c, d, p and f are:
0.0≦a≦0.1
0.0≦b≦0.3
0.0≦c≦0.4
0.05≦d≦0.3
0.1≦p≦0.5
0.0<f≦0.25

4. A photoluminescent material according to claim 1, wherein the variables are:
0.0≦a≦0.1
0.1≦b≦0.3
0.0≦c≦0.4
0.0≦d≦≦0.3

5. A photoluminescent material according to claim 1, wherein the variables are:
0.0≦a≦0.1
0.1≦b≦0.3
0.0≦c≦0.4
0.05≦d≦0.3
0.0≦p≦0.5
0.0≦f≦0.25

6. A photoluminescent material according to claim 1, wherein the variables are:
0.1≦a≦0.1
0.0≦b≦0.3
0.0≦c≦0.4
0.05≦d≦0.3
0.1≦p≦0.5
0.0≦f≦0.25

7. A photoluminescent material according to claim 1, wherein the variables are:
0.1≦a≦0.1
0.0≦b≦0.3
0.0≦c≦0.4
0.0≦d≦0.3
0.1≦p≦0.5
0.0≦f≦0.25

8. A photoluminescent material according to claim 1, wherein the variables are:
0.1≦a≦0.1
0.0≦b≦0.3
0.0≦c≦0.4
0.05≦d≦0.3
0.1≦p≦0.5

9. A photoluminescent material comprising 0.04Na0.25Sr0.23Al0.12Si0.32P07:0.005Eu0.02Dy 0.032Na0.26Sr0.21Al0.09Si0.25P07:0.006Eu0.028Dy 0.02Na0.16Sr0.09Ca0.27Al0.09Si0.21P07:0.007Eu0.026Dy 0.024K0.17Sr0.11Ca0.26Al0.10Si0.22PO7:0.007Eu0.026Dy

10. A method of manufacturing a photoluminescent material of claim 1 comprising the step of providing alkaline earth metal aluminate and reacting with a phosphorus containing acid resulting in an alkaline earth metal alumino-phosphate.

11. A method according to claim 3, wherein the alumino phosphate is reacted with liquid silicate resulting in a complex of an alkaline earth metal alumino-phospho-silicate.

12. A method of manufacturing a photoluminescent material of claim 1 comprising the step of providing an alkaline earth metal aluminate and reacting with liquid silicate resulting in formation of a complex alumino-silicate.

13. A method of manufacturing a photoluminescent material of claim 1 comprising a sol-gel process.
